(19) United States
(12) Patent Application Publication
(10) Pub. No.: US 2018/0029324 A1
(43) Pub. Date: Feb. 1, 2018

(54) RECLOSABLE POLYMERIC BAG

(71) Applicant: Poly-America, L.P., Grand Prairie, TX (US)

(72) Inventor: Brad A. Cobler, Irving, TX (US)

(21) Appl. No.: 15/220,842

(22) Filed: Jul. 27, 2016

(51) Int. Cl. B31B 23/00; B31B 1/18; B31B 1/62; B31B 1/64; B65D 33/25; B31B 1/90

(52) U.S. Cl. CPC B31B 23/00; B65D 33/2566; B31B 1/90; B31B 1/62; B31B 1/64; B31B 1/18; B31B 2219/146; B31B 2219/6061; B31B 2219/6007; B31B 2219/9019; B31B 2237/60

(57) ABSTRACT

The present invention relates to improvements for reclosable polymeric bags. Disclosed is a polymeric film bag with film made from a blown film extrusion or a cast extrusion process. The bag is formed from a continuous multi-layer web of polymeric film. The bag comprises burn through side seals formed by a rotary drum that forms the sides of the bag and severs the film of the multi-layer film to form individual bags. Interlocking zipper stock is provided to the web and affixed to an upper end of the bag by an adhesive. Further disclosed is a high-speed continuous process and system for manufacturing the reclosable bags.

### CROSS-REFERENCE TO RELATED APPLICATIONS

Not applicable.

### BACKGROUND OF THE INVENTION

### 1. Field of the Invention

The present invention relates to an improved reclosable storage bag made from polymeric film. Particularly, the present invention relates to a bag with a closure mechanism of interlocking profiles that is adapted for high speed and cost effective manufacturing.

### 2. Description of the Related Art

Thermoplastic films are used in a variety of applications. For example, thermoplastic films are used in sheet form for applications such as drop cloths, vapor barriers, and protective covers. Thermoplastic films can also be converted into plastic bags, which may be used in a myriad of applications. The present invention is particularly useful for reclosable bags constructed from thermoplastic film.

Polymeric bags are ubiquitous in modern society and are available in countless combinations of varying capacities, thicknesses, dimensions, and colors. The bags are available for numerous applications including typical consumer applications such as long-term storage, food storage, shopping, and trash collection. Like many other consumer products, increased demand and new technology have driven innovations in polymeric bags improving the utility and performance of such bags. The present invention is an innovation of particular relevance to reclosable storage bags of polymeric film.

Polymeric bags are manufactured from polymeric film produced using one of several manufacturing techniques well known in the art. The two most common methods for manufacture of polymeric films are blown-film extrusion and cast-film extrusion. In blown-film extrusion, the resulting film is tubular while cast-film extrusion produces a generally planar film. The present invention is generally applicable to bags manufactured from a blown-film extrusion process resulting in tubular film stock and cast film which results in monolayer film stock.

In blown film extrusion, polymeric resin is fed into an extruder where an extrusion screw pushes the resin through the extruder. The extrusion screw compresses the resin, heating the resin into a molten state under high pressure. The molten, pressurized resin is fed through a blown film extrusion die having an annular opening. As the molten material is pushed into and through the extrusion die, a polymeric film tube emerges from the outlet of the extrusion die.

The polymeric film tube is blown or expanded to a larger diameter by providing a volume of air within the interior of the polymeric film tube. The combination of the volume of air and the polymeric film tube is commonly referred to as a bubble between the extrusion die and a set of nip rollers. As the polymeric film tube cools travelling upward toward the nip rollers, the polymeric film tube solidifies from a molten state to a solid state after it expands to its final diameter and thickness. Once the polymeric film tube is completely solidified, it passes through the set of nip rollers and is collapsed into a collapsed polymeric tube, also referred to as a collapsed bubble.

Cast film is extruded from a flat die into a flat web or sheet. Typically, the film is extruded onto a chilled roller to facilitate quick cooling of the film for improved throughput.

Reclosable plastic bags are available in a variety of different sizes and configurations. Most commonly, reclosable plastic bags have one or more pairs of opposing, interlocking closures near the top opening of the reclosable bag. The closure may generally be opened and closed many times and are typically designed to ensure that the contents of the reclosable plastic bag are securely contained within the bag when the opposing closures, or interlocking profiles, are mutually engaged.

The closures of reclosable bags can be opened and closed in a number of different ways. For example, a slider or zipper device can be incorporated into the bag design to facilitate the engagement and disengagement of the opposing closures. However, many reclosable bags have closures that are designed to be opened by physically pulling the closures apart. The present invention provides an improved system and method of manufacturing a reclosable bag with pull-apart closures, commonly referred to as press to close reclosable bags. The assembly of closure elements for press to close bags is typically referred to as a zipper even though an actual sliding zipper is not employed.

U.S. Pat. No. 3,565,147 (the '147 patent) discloses a plastic bag having male and female resealable interlocking elements integrally incorporated for selectively opening and closing the top of the bag. Since the '147 patent discloses forming the interlocking elements integrally with the bag film material, the formation of the bag takes an undesirably long time to form due to the additional cooling time required of the fasteners to prevent deformation of the fastening elements.

It is further known that interlocking elements, also referred to as zipper elements, may be formed separately from the bag material and then sealed onto the bag material. However, this bag manufacturing technique requires the use of non-continuous motion which leads to an undesirably slow rate of manufacture. It also known to place the zipper elements on to the bag material in a molten state as the bag film material is formed. However, the speed of this bag manufacturing technique is limited to the rate at which the molten zipper may be properly formed.

In consideration of the shortcomings of the above discussed prior art, it would be desirable to provide a system and method for manufacturing a reclosable bag that may be formed with a continuous process. It would further be desirable to provide such a bag that takes advantage of high-speed manufacturing processes utilizing blown-film roll stock. The present invention represents a novel solution to address these needs.

### SUMMARY OF THE INVENTION

According to one embodiment of the present invention, a bag is formed from a continuous web of polymeric film by a first bag converting process. A multi-layer continuous web of polymeric film with opposing first and second folded edges may be supplied to the converting process. The continuous web may comprise a lower layer extending from the first to the second edge, a first upper flap above the lower layer extending from the first edge towards a longitudinal central axis of the continuous web, and a second upper flap above the lower layer extending from the second edge towards the longitudinal central axis. A length of the continuous web may extend lengthwise in a machine direction. In at least one embodiment of the present invention, the bag converting process may fold a web of material accordingly to arrive at the above-described configuration of the continuous web.

Once the multi-layer web is provided as described above, a zipper material that extends in the machine direction may be provided to the converting process. The zipper material may comprise upper and lower mutually interlocking sections and upper and lower mounting surfaces. An adhesive may be applied to each mounting surface of the zipper material. The lower mounting surface of the zipper material may be affixed to an inner surface of the lower layer of the continuous web and the upper mounting surface of the zipper material may be affixed to inner surfaces of the first and second flaps of the continuous web by the adhesive. Once the zipper material is affixed to the continuous web, the continuous web may be slit in the machine direction into a first web half and a second web half along the central axis of the continuous web in the machine direction. A plurality of side seals may then be formed in each web half by a burn through seal operation. Each side seal may seal the first and second flaps to the lower layer of the continuous web and the burn through seals may further sever the polymeric film of the continuous web to form a plurality of individual bags.

In certain embodiments of the present invention, a gap may be defined between a distal edge of the first flap and a distal edge of the second flap. The gap may be formed by removal of a center strip from an upper layer of the web of polymeric film. The lower mounting surface of the zipper material may be affixed to the inner surface within the gap between the distal edge of the first and second flaps. Furthermore, the zipper material may be slit in conjunction with the continuous web such that it separates apart first and second sections of the zipper material. The distal edge of the first flap may be moved towards the first folded edge and the distal edge of the second flap may be moved towards the second folded edge prior to affixing the zipper material to the continuous web. The distal edge of the first and second flaps may also be moved back towards each other once the zipper material is affixed to the continuous web.

In at least certain embodiments, the upper zipper section may be comprised of first and second zipper sections. Each upper zipper section may have a separate base with a separate mounting surface. The lower zipper section may comprise first and second lower sections. The first and second lower zipper sections may share a common base with a single mounting surface. The mounting surface of the first upper zipper section may be mounted to the first flap and the mounting surface of the second upper section may be mounted to the second flap. Each of the zipper sections may further comprise an interlocking profile opposite from its base. Additionally, the plurality of side seals may be formed by a rotary sealing drum comprising a plurality of sealing bars.

In a further embodiment of the present invention, a bag is formed from a tube of polymeric film by a second bag converting process. In the bag converting process the tube of polymeric film may be collapsed to form a collapsed tube. The collapsed tube may have upper and lower layers, opposing first and second folded edges, and a machine direction. A center strip may be removed from the upper layer of the collapsed tube with a length of the center strip extending in the machine direction. The removal of the center strip may then form first and second flaps in the upper layer of the collapsed tube. A distal edge of the first and second flaps may then be moved away from each other and towards the first and second folded edges to expose a central inner surface of the lower layer of the collapsed tube.

Once the central inner surface of the lower layer of the collapsed tube is exposed, zipper stock comprising first and second upper and first and second lower sections may be supplied to the collapsed tube. Each section of the zipper stock may comprise a mounting surface and an adhesive may be applied to each mounting surface. The mounting surface of the first and second lower zipper sections may be affixed to the collapsed tube by the adhesive. The distal edge of the first and second flaps may be folded or moved back towards each other and thereafter the mounting surface of the first upper zipper sections may be affixed to an inner surface of the first flap by the adhesive. The mounting surface of the second front upper section may also be affixed to an inner surface of the second flap by the adhesive. Once the zipper stock is affixed to the collapsed tube, the collapsed tube may be slit into a first collapsed tube half and a second collapsed tube half. A plurality of burn through side seals may be formed in each collapsed tube half by a rotary drum severing the polymeric film of the collapsed tube at each side seal to form a plurality of individual bags.

In at least one embodiment, pressure may be applied to the zipper stock and the collapsed tube by a set of rollers to ensure adequate adhesion between the two once the zipper stock is placed on the collapsed tube. Additionally, the mounting surface of the lower zipper section may be affixed to the collapsed tube at a central inner surface of the collapsed tube. The mounting surface of the first upper zipper section may be affixed to the inner surface of the first flap proximate to a distal edge of the first flap and the mounting surface of the second front upper zipper section may be affixed to the inner surface of the second flap proximate to a distal edge of the second flap. The lower zipper sections may share a common base with a single mounting surface. The first lower zipper section may be interlocked with the first front zipper section and the second rear zipper section may be interlocked with the second front zipper section. Furthermore, each side seal formed on each collapsed tube half may be generally perpendicular to the machine direction. The rotary drum may feed the individual bags to a belt material handler and the belt material handler may feed the individual bags onto an indexing table. The first upper and lower zipper sections may be separated from the second upper and lower zipper sections when slitting the collapsed tube into a first collapsed tube half and a second collapsed tube half.

In an alternative embodiment of the present invention a reclosable bag may be formed from a web of polymeric film. Front and rear panels of the reclosable bag may be joined at a first side and a second side by opposing first and second side seals and at a folded bottom edge. The reclosable bag may be selectively closable at a top end opposite from the bottom edge by a zipper. The zipper may comprise a lower section and an upper section. The lower section may be affixed to an inner surface of the rear panel by a first layer of adhesive and the upper section may be affixed to an inner surface of the front panel by a second layer of adhesive.

In certain embodiments, the front and rear panels may be formed from upper and lower layers of a collapsed tube of polymeric film. Furthermore, the bottom edge of the reclosable bag may comprise a section of a folded edge of the collapsed tube. The top end of the reclosable bag may comprise a center section of the collapsed tube with the collapsed tube slit generally along a centerline in a machine direction of the collapsed tube. Additionally, the lower and upper sections of the zipper may be adapted to be pulled apart to open the bag and pressed together to close the bag.

It is contemplated that the present invention may be utilized in ways that are not fully described or set forth herein. The present invention is intended to encompass these additional uses to the extent such uses are not contradicted by the appended claims. Therefore, the present invention should be given the broadest reasonable interpretation in view of the present disclosure, the accompanying figures, and the appended claims.

### BRIEF DESCRIPTION OF THE RELATED DRAWINGS

A full and complete understanding of the present invention may be obtained by reference to the detailed description of the present invention and the preferred embodiments when viewed with reference to the accompanying drawings. The drawings can be briefly described as follows.

FIG. 1a provides a side view of a method and system for forming a reclosable bag.

FIG. 1b provides an alternative embodiment of a method and system for forming a reclosable bag.

FIGS. 2a1, 2a2 and 2b-2f provide cross-sectional views of a continuous web as the web is formed into a plurality of reclosable bags according to the methods of FIGS. 1a and 1b.

FIGS. 3a and 3b provide detailed cross-sectional views of a zipper stock or material utilized to form the reclosable bags according to the methods of FIGS. 1a and 1b.

FIGS. 4a-4c provide top views of the continuous web as it is formed into the plurality of reclosable bags according to the methods of FIGS. 1a and 1b.

FIGS. 5a-5c provide a front view, cross-sectional side view, and a detailed cross-sectional side view of the reclosable bag formed by the methods of FIGS. 1a and 1b.

### DETAILED DESCRIPTION OF THE INVENTION

The present disclosure illustrates one or more preferred embodiments of the present invention. It is not intended to provide an illustration or encompass all embodiments contemplated by the present invention. In view of the disclosure of the present invention contained herein, a person having ordinary skill in the art will recognize that innumerable modifications and insubstantial changes may be incorporated or otherwise included within the present invention without diverging from the spirit of the invention. Therefore, it is understood that the present invention is not limited to those embodiments disclosed herein. The appended claims are intended to more fully and accurately encompass the invention to the fullest extent possible, but it is fully appreciated that certain limitations on the use of particular terms is not intended to conclusively limit the scope of protection.

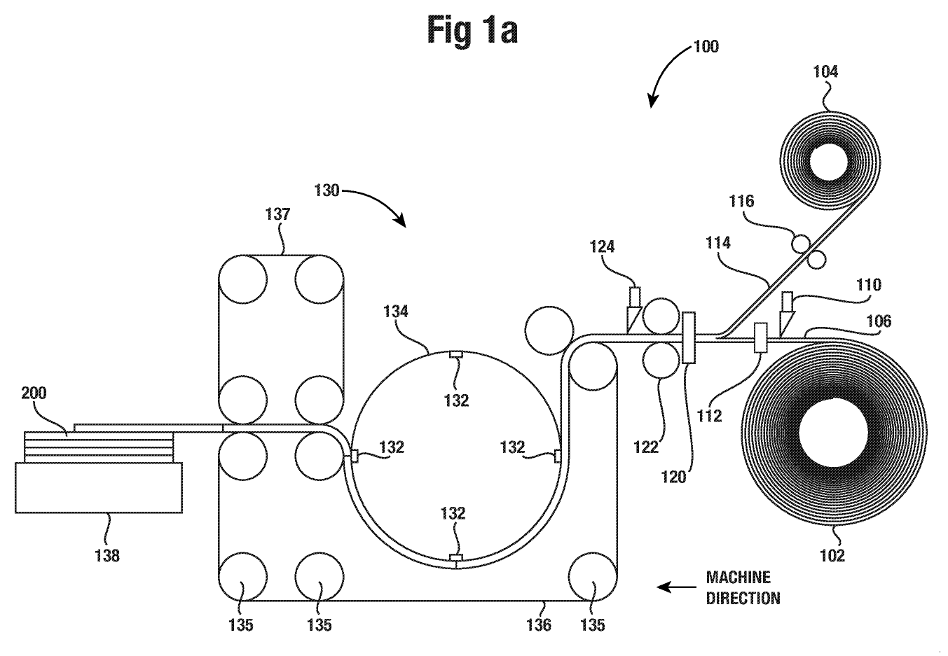

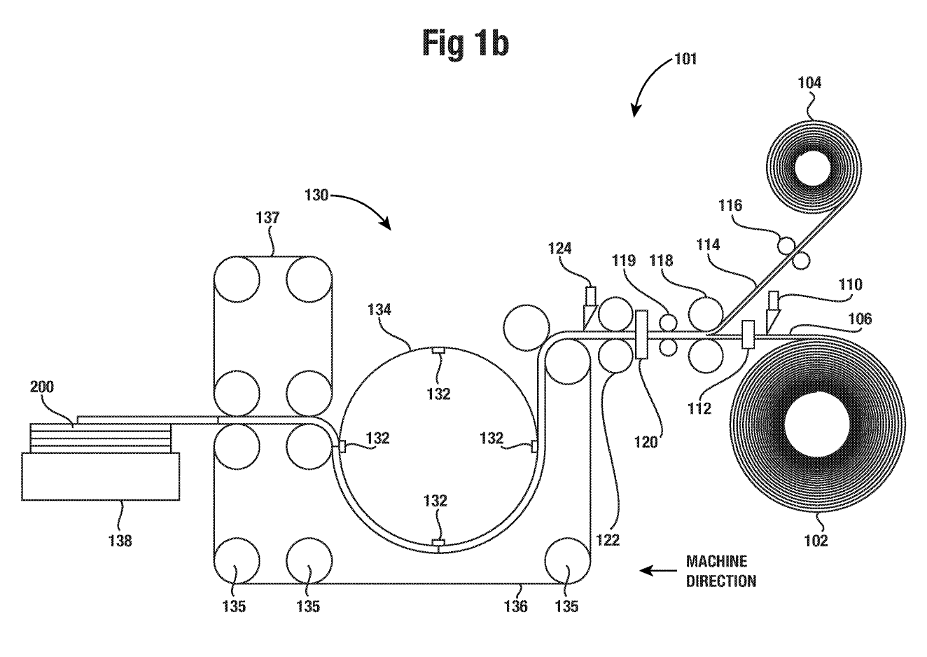

FIG. 1a provides a side view of a system for forming reclosable bags from a continuous web of polymeric film. The web is shown provided to the system as roll stock. The web can be formed by a blown film extrusion or a cast film extrusion process.

The extrusion process begins by molten polymeric resin being extruded through a die to form a web of molten polymeric film. The direction that the film is extruded out of the die is commonly referred to as the machine direction. The direction of extrusion may also be referred to as the lengthwise direction of the web. Hence, the length of the web extends parallel with the machine direction. The direction transverse to the machine direction is commonly referred to as the cross direction.

The polymeric resin used in the extrusion process may vary. However, for forming polymeric bags, a polyethylene resin is commonly used. In the current state of the art for polymeric bags, a blend of various polyethylene polymers may be used. A polymer blend can have linear low-density polyethylene (LLDPE) as the primary component, but other polymers may be utilized including, but not limited to, other polyethylene resins such as high-density polyethylene (HDPE) or low-density polyethylene (LDPE). Other than polyethylene and other related polymers, additives may also be included with the polymeric resin, such as coloring additives, anti-blocking agents, and/or odor control additives.

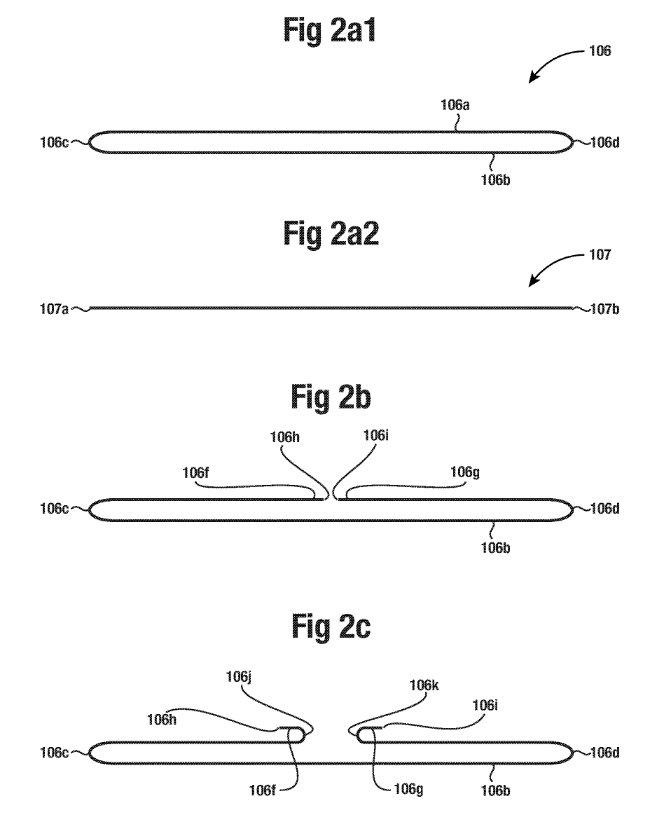

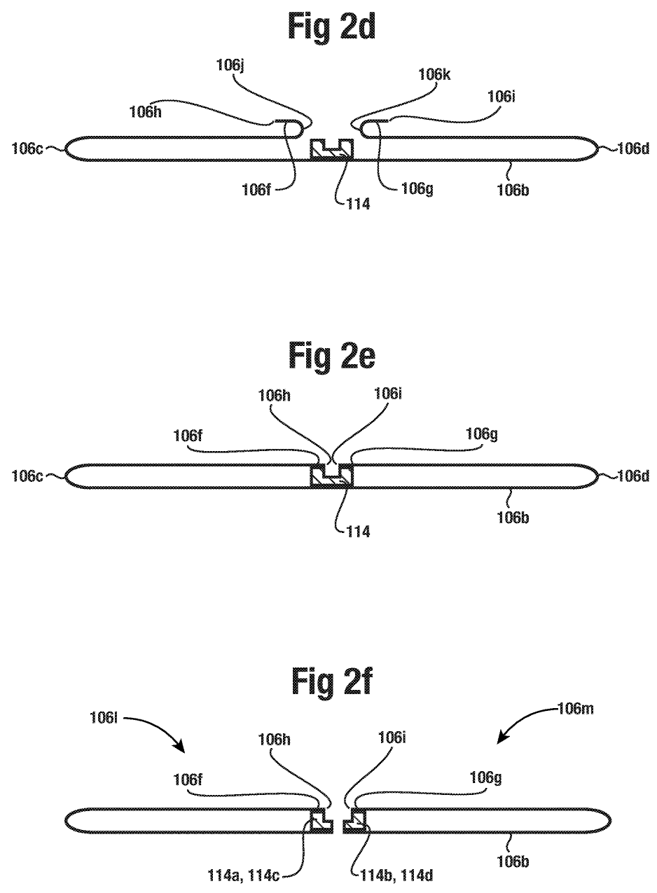

As shown in FIG. 1a, a roll stock 102 of a continuous web 106 of polymeric film is provided to the bag converting system 100. As used herein, the term continuous web refers to the web being continuous and unbroken through the bag converting process until it is formed into individual bags. FIG. 2a1 shows a cross-sectional view of web 106 that can be provided by roll stock 102. FIG. 2a1 illustrates continuous web 106 as a collapsed tube of polymeric film, typically manufactured by a blown film extrusion process. Web 106 is shown having an upper layer 106a and an opposite lower layer 106b, and a first folded edge 106c and an opposite second folded edge 106d. For ease of illustration, web or tube 106 is shown with a gap between its upper and lower layers 106a and 106b; however, typically, the inner surfaces of the two layers of collapsed tube 106 will be in contact with each other with the layers of web 106 essentially flat.

As further shown in FIG. 1a, once web 106 is unrolled such that it extends lengthwise in its machine direction, a trimming operation 110 can trim a center strip of film from the upper layer 106a from web 106. The removed center strip extends with its length in the machine direction. In at least one alternative embodiment, the trimming of center strip can be integrated into the extrusion process of web 106 such that after the film is formed, such as by a blown film extrusion process, the center strip can be removed prior to the web of film being rolled into roll stock.

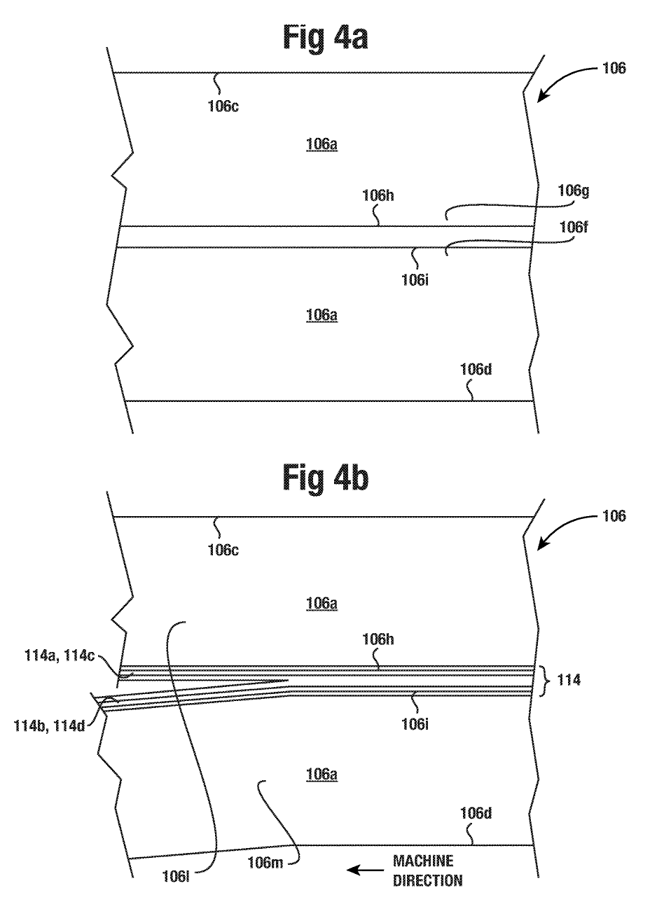

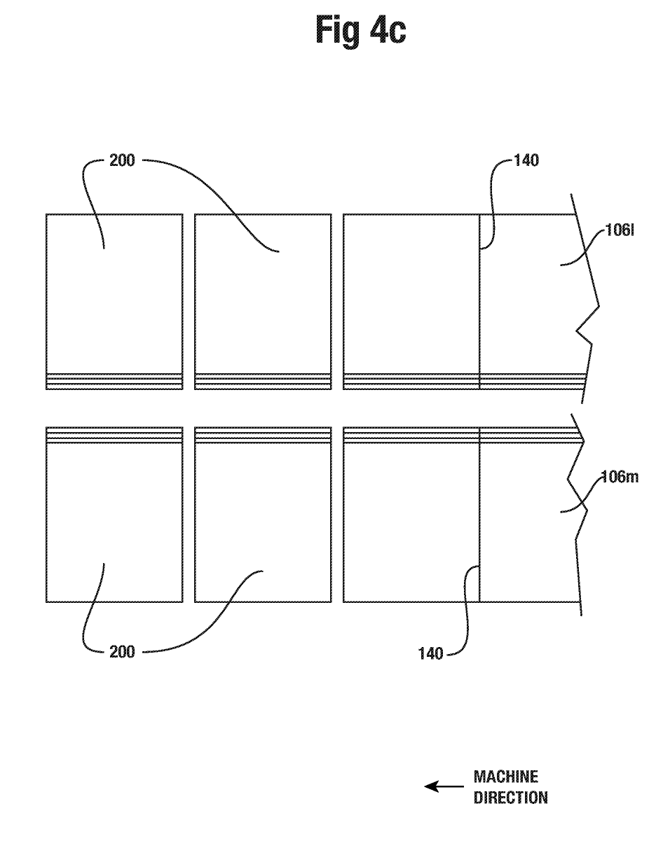

Illustrated in FIG. 2b is a cross-sectional view of web 106 with the center strip removed, which results with a gap in upper layer 106a of web 106. The forming of the gap in upper layer 106a results in the forming of first and second flaps 106f and 106g in upper layer 106a. The trimming of the center strip further results in distal edges 106h and 106i defined in first and second flaps 106f and 106g. Further shown by FIG. 4a is a top view of web 106 after the trimming operation defines flaps 106f and 106g, and distal edges 106h and 106i in web 106 with distal edges 106h and 106i extending in the machine direction of web 106. After removal of the center strip, FIG. 2c illustrates that flaps 106h and 106i folded or moved away from the centerline of web 106 with the distal edges moved closer to adjacent web edges 106b and 106c. The process of folding or rotating of flaps 106h and 106i is illustrated in FIG. 1a by folding operation 112. It may be desirable for folding operation 112 to not form creases in web 106 since flaps 106h and 106i are only temporarily moved or folded away to allow placement of zipper stock 114 onto web 106.

Rather than roll stock 102 comprising a collapsed tube of polymeric film as discussed above, in an alternative embodiment, roll stock 102 can be comprised of a single layer of a continuous web of polymeric film 107 as shown in the cross-sectional view of FIG. 2a2. For ease of illustration, web 107 is not shown to scale, with its width less than would be required to form the two-layered web of FIG. 2b. For this embodiment, trimming operation 110 is not necessary. However, folding operation 112, in this alternative embodiment, can fold the opposing distal edges 107a and 107b of web 107 towards a centerline of continuous web 107. Once both distal edges are folded towards each other, the single layer web 107 of FIG. 2a2 can take the form of the continuous web 106 of the cross-section as shown in FIG. 2b. The folding results in distal edges 107a and 107b relocated towards a centerline of continuous web 106 with the distal edges 107a and 107b taking the place of distal edges 106h and 106i. The folding operation can further define the outer edges 106c and 106d with upper flaps 106f and 106g extending from the edges 106c and 106d towards a centerline of web 106 and opposite from lower layer 106b. Once single layered web 107 of FIG. 2a2 is folded into the configuration as shown in FIG. 2b to form web 106 with two layers, folding operation can continue as described above to arrive at the configuration of web 106 is shown in FIG. 2c.

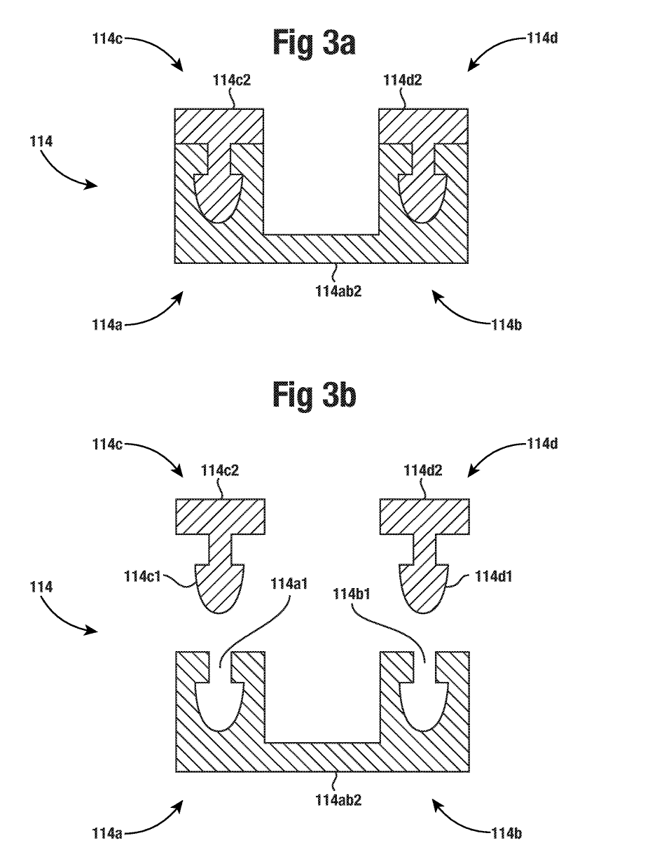

Once flaps 106h and 106i are moved towards the position shown in FIG. 2c, zipper stock or zipper material 114 may be supplied to web 106 as illustrated in FIG. 1a. Zipper stock 114 is supplied to the bag conversion process from zipper roll stock 104. Shown in FIGS. 3a and 3b is a detailed cross-sectional view of zipper stock 114. FIG. 3a shows zipper stock fully assembled while FIG. 3b shows an exploded cross-sectional view of the zipper assembly including first and second lower zipper sections 114a and 114b and first and second upper zipper sections 114c and 114d. As shown in FIG. 3a, the lower sections can interlock with the upper sections. First and second lower zipper sections 114a and 114b further include first and second lower interlocking profiles 114a1 and 114b1 and a common base 114ab2 that interconnects first and second lower sections 114a and 114b. The common base 114ab2 includes a generally flat mounting surface on an opposite side of zipper sections 114a and 114b from interlocking profiles 114a1 and 114b1 .

As further shown in FIGS. 3a and 3b, first and second upper sections 114c and 114d have interlocking profiles 114c1 and 114d1 along with separate opposing bases 114c2 and 114d2. Bases 114c2 and 114d2 include a generally flat mounting surface on an opposite side of each zipper section from interlocking profiles 114c1 and 114d1. In at least one embodiment, the profiles of zipper stock 114 disclosed in FIGS. 3a and 3b can extend throughout the length of zipper stock or zipper material 114. For ease of illustration, the details of zipper stock 114 are only shown in FIGS. 3a and 3b while other figures of the disclosure refer to zipper stock 114 in general. FIGS. 3a and 3b disclose a rudimentary interlocking zipper design; however, the invention contemplates that multitudes of various zipper configurations that are known in the art can be adapted for use with the disclosed invention. In at least one embodiment, the zipper stock 114 can be formed by extrusion into a water bath for improved cooling of the molten material

As further shown in FIG. 1a, prior to zipper stock 114 being supplied to the converting system, an adhesive can be applied to the mounting surfaces of bases 114ab2 , 114c2, and 114d2 by adhesive applicator 116. Adhesive applicator may comprise open cell foam rollers that deliver a pressure sensitive adhesive to the bases of the mounting bases of zipper stock 114. Adhesive applicator may also comprise hot melt applicators that supply a hot melt adhesive to the mounting surfaces of zipper stock 114. Adhesive may also be applied to the mounting surface of zipper stock or material 114 by other various methods as known in the art.

Once the adhesive is applied to the mounting surfaces of the zipper stock 114, the zipper stock 114 may be placed on to web 106 with the mounting surface of lower common base 114ab2 placed into contact with an inner surface of the lower layer 106b of web 106, as shown in the cross-sectional view of FIG. 2d. Once placed into contact, the inner surface of web 106 is affixed to mounting surface of base 114ab2 by the adhesive between the mounting surface and inner surface of the web.

As additionally shown in FIG. 1a, a further folding operation 120 can fold or move back flaps 106f and 106g of web 106 to their original position so that an inner surface of the flaps are placed in contact with the adhesive on the mounting surfaces of the upper section zipper bases 114c2 and 114d2. FIG. 2e illustrates the cross-sectional view of web 106 once this step is completed. As further shown in FIG. 1a, applicator rollers 122 can apply pressure to the outer surfaces of web 106 and zipper stock 114 to ensure that adequate pressure is applied to the adhesive to adhere web 106 and zipper stock 114 together at upper zipper section bases 114c2 and 114d2 and lower zipper section base 114ab2 .

Once the upper zipper sections 114c and 114d are affixed to web 106, web 106 can be slit along its central axis so that it is split into a first and second web halves 106l and 106m as shown in FIG. 2f. The web 106 can be split into the first and second halves 106l and 106m by a slitting operation 124 as shown in FIG. 1a. In at least one preferred embodiment, the slitting operation 124 extends along a central axis of the continuous web 106, the central axis extending in the machine direction of the web 106 and centrally located between the opposing edges 106c and 106d. The slitting operation 124 further slits zipper stock 114 into two halves about lower zipper section base 114ab2 . The slitting of zipper stock 114 results in first upper and lower zipper sections 114a and 114c defining an enclosed edge of the first web half 106l and second upper and lower zipper section 114b and 114d defining an enclosed edge of second web half 106m as illustrated in FIG. 2f.

FIG. 4b further provides a top view of web 106 after zipper stock 114 is affixed to web 106. FIG. 4b further shows web 106 split into two halves 106l and 106m by slitting operation 124 as the web 106 travels in the machine direction. Web halves 106l and 106m are shown with a gap between each other for purposes of illustration. It is contemplated, however, that both halves 106l and 106m will remain travelling substantially in the machine direction and adjacent to each other until the bag manufacturing process is completed.

Once the web 106 is split into halves 106l and 106m, the two halves may enter side-sealing operation 130 as further shown in FIG. 1a. The sealing operation 130 is shown with a rotary drum 134 with a plurality of sealing bars 132. Each of the sealing bars 132 can form a burn through seal on both the web halves 106l and 106m which seals together the upper and lower layers 106a and 106b of web halves 106l and 106m. Web halves 106l and 106m can be held in place against sealing drum by sealing drum blanket or belt 136 working in conjunction with a plurality of rollers 135. Each of the seal bars 132 can extend in a direction perpendicular to the machine direction so that each side seal is generally perpendicular to web edges 106c and 106d and zipper stock 114.

As further illustrated in FIGS. 1a and 4c, the burn through seals weld together and sever both layers of film of the upper and lower layers 106a and 106b to separate each web half 106l and 106m into a plurality of bags 200. FIG. 4c illustrates a planar top view of web halves 106l and 106m as sealing operation 130 produces a plurality of burn through side seals 140 on web halves 106l and 106m and forms a plurality of bags 200 from web halves 106l and 106m as the two halves travel in the machine direction. The use of rotary drum 134 allows for conversion process 100 to be continuous such that continuous web 106 travels at a constant speed from being fed from roll stock 102 until web 106 is formed into individual bags. This is in contrast to a reciprocating process, where web 106 would be required to vary in speed and where seal bars would need to move back and forth to engage and disengage web 106.

As further shown in FIG. 1a, once web halves 106l and 106m are converted into a plurality of bags 200 by sealing operation 130, belt 136 in conjunction with belt conveyance or material handler 137 can deliver the plurality of bags 200 to index table 138 which can vertically stack a quantity of bags 200 for packaging.

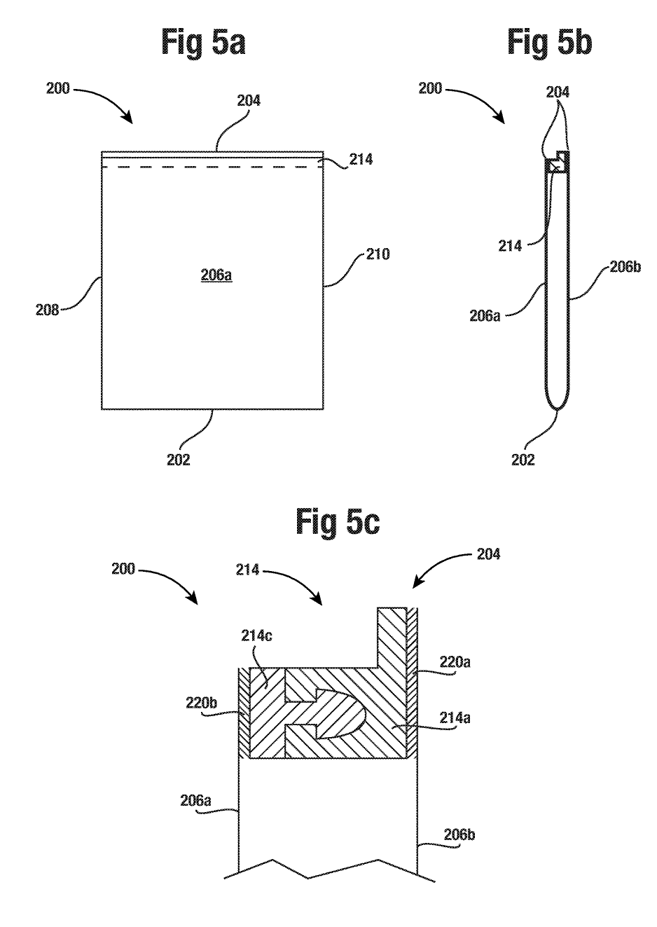

FIGS. 5a and 5b illustrate a front view and cross-sectional side view of bag 200 formed by the aforementioned bag manufacturing method and system 100. Bag 200 is shown with zipper 214 which corresponds to a length of zipper stock 114. Further shown are first and second side edges 208 and 210 formed by one of the plurality of sealing bars 132 of FIG. 1a. Also shown is a top edge and opening of bag 204 which corresponds to one of the distal edges 106h or 106i of web 106. Additionally, bottom folded edge 202 is shown which corresponds to either side edge 106c or 106d of web 106. Further shown by FIG. 5b are a front panel 206a and a rear panel 206b of bag 200 which correspond to a partial section of lower and upper layers 106a and 106b of web 106. Lower and upper layers 106a and 106b are sealed together at edges 208 and 210 due to the aforementioned sealing operation 130.

Shown in FIG. 5c is a detailed cross-sectional view of an upper section of bag 200. FIG. 5c shows a lower section 214a of zipper 214, which corresponds to a section of first lower section 114a of zipper stock 114. The lower zipper section 214a is shown affixed to the rear panel 206b of bag 200 by an adhesive layer 220a. FIG. 5c further shows an upper section 214c of zipper 214, which corresponds to a section of first upper section 114c of zipper stock 114. Upper zipper section 214c is shown affixed to the front panel 206a of bag 200 by an adhesive layer 220b. The two zipper sections 214a and 214c are shown joined together to form an enclosed upper edge 204 of bag 200. A user of bag 200 may pull apart the two zipper sections 214a and 214c to open the bag and press back together the two zipper sections 214a and 214c to reclose bag 200.

Now turning to FIG. 1b, the figure illustrates an alternative embodiment of the aforementioned system and method. The bag making method 101 disclosed by FIG. 1b only differs by the steps regarding the application of the adhesive to zipper stock 114 and adhering the zipper stock to web 106. Hence, only these steps are explained for FIG. 1b while the remaining steps mirror the process for the FIG. 1a embodiment. Beginning with adhesive applicator 116, the applicator may only apply adhesive to zipper stock 114 along the mounting surface of lower base 114ab2 (as shown by FIGS. 3a and 3b). Zipper stock 114 may then be placed into contact with web 106 with lower base 114ab2 affixed to the inner surface of the lower layer 106b of web 106. Whereupon, pressure rollers 118 may apply pressure to zipper stock 114 and web 106. Additional adhesive applicator 119, as shown in FIG. 1b, may then apply adhesive to upper bases 114c2 and 114d2. Then, folding operation 120 may fold flaps 106f and 106g back and place the flaps on to upper bases 114c2 and 114d2 (as shown by FIGS. 3a and 3b). Pressure rollers 122 may then apply pressure to zipper stock 114 and web 106 to ensure the adhesive on upper bases is adequately affixed to the zipper stock 114 and web 106. The process may then proceed as previously discussed for FIG. 1a.

As previously noted, the specific embodiments depicted herein are not intended to limit the scope of the present invention. Indeed, it is contemplated that any number of different embodiments may be utilized without diverging from the spirit of the invention. Therefore, the appended claims are intended to more fully encompass the full scope of the present invention.

I claim:

1. A method of forming a bag from a continuous web of polymeric film, the method comprising:
supplying the continuous web of polymeric film with opposing first and second folded edges, wherein the continuous web further comprises: a lower layer extending from the first to the second edge, a first upper flap above the lower layer extending from the first edge towards a central axis of the continuous web, a second upper flap above the lower layer extending from the second edge towards the central axis, and the continuous web extending lengthwise in a machine direction,
supplying a zipper material extending in the machine direction, the zipper material comprising upper and lower interlocking sections and upper and lower mounting surfaces,
applying an adhesive to each mounting surface of the zipper material,
the adhesive affixing the lower mounting surface of the zipper material to an inner surface of the lower layer of the continuous web,
the adhesive affixing the upper mounting surface to inner surfaces of the first and second flaps of the continuous web,
slitting the continuous web in the machine direction into a first web half and a second web half along the central axis of the continuous web, and
forming a plurality of side seals in each web half, the side seals sealing the first and second flaps to the lower layer of the continuous web and severing the polymeric film of the continuous web to form individual bags.

2. The method of claim 1 further comprising:
a gap defined between a distal edge of the first flap and a distal edge of the second flap.

3. The method of claim 1 further comprising:
the gap between the distal edges of the first and second flaps formed by removal of a center strip from an upper layer of the web of polymeric film.

4. The method of claim 3 further comprising:
the lower mounting surface of the zipper material affixed to the inner surface between the distal edge of the first and second flaps.

5. The method of claim 1 further comprising:
the zipper material slit in conjunction with the continuous web and separating apart first and second sections of the zipper material.

6. The method of claim 1 further comprising:
a distal edge of the first flap moved towards the first folded edge and a distal edge of the second flap moved towards the second folded edge prior to affixing the zipper material to the continuous web.

7. The method of claim 6 further comprising:
the distal edge of the first and second flaps moved towards each other once the zipper material is affixed to the continuous web.

8. The method of claim 7 further comprising:
the upper zipper section comprising first and second upper zipper sections, each upper section having a separate base with a separate mounting surface,
the lower section comprising first and second lower sections, the first and second lower sections sharing a common base with a mounting surface, and
the mounting surface of the first upper section mounted to the first flap and the mounting surface of the second upper section mounted to the second flap.

9. The method of claim 8 further comprising:
each of the zipper sections comprising an interlocking profile opposite from its base.

10. The method of claim 1 further comprising:
the plurality of side seals formed by a rotary sealing drum comprising a plurality of sealing bars.

11. A method of forming a bag from a tube of polymeric film, the method comprising:
collapsing the tube to form a collapsed tube, the collapsed tube having opposing upper and lower layers, opposing first and second folded edges, and a machine direction,
removing a center strip from the upper layer of the collapsed tube, a length of the center strip extending in the machine direction,
forming first and second flaps in the upper layer of the collapsed tube by removal of the center strip,
moving a distal edge of the first and second flaps away from each other and towards the first and second folded edges to expose a central inner surface of the lower layer of the collapsed tube,
supplying zipper stock comprising first and second upper and first and second lower sections, each section comprising a mounting surface,
applying an adhesive to each mounting surface of the zipper stock,
the adhesive affixing the mounting surface of the first and second lower zipper sections to the collapsed tube,
moving the distal edge of the first and second flaps back towards each other,
the adhesive affixing the mounting surface of the first upper zipper sections to an inner surface of the first flap,
the adhesive affixing the mounting surface of the second front upper section to an inner surface of the second flap,
slitting the collapsed tube into a first collapsed tube half and a second collapsed tube half, and
forming a plurality of side seals in each collapsed tube half by a rotary drum, each side seal severing the polymeric film of the collapsed tube to form individual bags.

12. The method of claim 11 further comprising:
applying pressure by a set of applicator rollers to an outer surface of the collapsed tube and zipper stock once the zipper stock is located on the collapsed tube.

13. The method of claim 11 further comprising:
the mounting surface of the lower zipper section affixed to the collapsed tube proximate to a central inner surface of the collapsed tube,
the mounting surface of the first upper zipper section affixed to the inner surface of the first flap proximate to a distal edge of the first flap, and
the mounting surface of the second front upper zipper section affixed to the inner surface of the second flap proximate to a distal edge of the second flap.

14. The method of claim 11 further comprising:
the lower zipper sections sharing a common base with a single mounting surface,
the first lower zipper section interlocked with the first front zipper section, and
the second rear zipper section interlocked with the second front zipper section.

15. The method of claim 11 further comprising:
each side seal generally perpendicular to the machine direction,
the rotary drum feeding the individual bags from both collapsed tube halves to a belt material handler, and
the belt material handler feeding the individual bags onto an indexing table.

16. The method of claim 11 further comprising:
separating the first upper and lower zipper sections from the second upper and lower zipper sections when slitting the collapsed tube into first and second collapsed tube halves.

17. A reclosable bag formed from a web of polymeric film comprising:
front and rear panels joined at a first side and a second side by side seals and at a folded bottom edge,
a selectively closeable top end opposite from the bottom edge,
a zipper proximate to the top end, the zipper comprising:
a lower section interlocked with an upper section,
the lower section affixed to an inner surface of the rear panel by a first layer of adhesive, and
the upper section affixed to an inner surface of the front panel by a second layer of adhesive.

18. The reclosable bag of claim 17 further comprising:
the front and rear panels formed from upper and lower layers of a collapsed tube of polymeric film, and
the bottom edge of the reclosable bag comprising a section of a folded edge of the collapsed tube.

19. The reclosable bag of claim 18 further comprising:
the top end of the reclosable bag comprising a center section of the collapsed tube, the collapsed tube slit generally along a centerline in a machine direction of the collapsed tube.

20. The reclosable bag of claim 17 further comprising:
the lower and upper sections of the zipper adapted to be pulled apart to open the bag and pressed together to close the bag.
